(19) United States
(12) Patent Application Publication
(10) Pub. No.: US 2019/0224884 A1
(43) Pub. Date: Jul. 25, 2019

(54) Production Of Pre-Stressed Concrete Structures Using Fibrous Reinforcing Tendons

(71) Applicant: Rockwerk Systems, Inc., Naperville, IL (US)

(72) Inventors: Jack DeWayne Rigsby II, Grantsburg, IL (US); Gerardo Ayala, Burbank, IL (US); Anthony Cellucci, Naperville, IL (US)

(21) Appl. No.: 16/375,260

(22) Filed: Apr. 4, 2019

Related U.S. Application Data
(63) Continuation of application No. PCT/US2017/056000, filed on Oct. 10, 2017.
(60) Provisional application No. 62/406,613, filed on Oct. 11, 2016.

(51) Int. Cl. B28B 23/04; E04C 5/07; E04C 5/08; E04G 9/10

(52) U.S. Cl. CPC B28B 23/043; E04G 9/10; E04C 5/085; E04C 5/073

(57) ABSTRACT

A pre-stressed cast concrete structure comprises embedded fibrous reinforcing tendons in tension. The fibrous reinforcing tendons each comprises a plurality of continuous non-metallic fibers extending substantially the entire length of the tendon. A system for pre-stressing a cast concrete structure includes a mold for containing concrete, fibrous reinforcing tendons, chuck assemblies associated with the reinforcing tendons and a tensioning mechanism. When cured, the concrete rigidly surrounds the reinforcing tendons such that the reinforcing tendons are maintained in tension. The chuck assemblies have a plurality of jaws that contact the reinforcing tendons in a manner to resist damage to the fibers.

### CROSS-REFERENCE TO RELATED APPLICATIONS

This application is a continuation of international application No. PCT/US2017/056000 filed on Oct. 10, 2017, entitled “Production of Pre-Stressed Concrete Structures Using Fibrous Reinforcing Tendons”. The '000 international application claimed priority benefits from U.S. provisional patent application Ser. No. 62/406,613 filed on Oct. 11, 2016, entitled “Concrete Pre-Stressed with Fiber Reinforced Polymers”. Then '000 international application and the '613 provisional application are each hereby incorporated by reference herein in their entirety.

### FIELD OF THE INVENTION

The present invention relates to the production of pre-stressed concrete, and in particular to the production of pre-stressed concrete using fibrous reinforcing tendons.

### BACKGROUND OF THE INVENTION

Civilizations have thrived and died based on the strength of their structures: the harsher the environment, the greater the demand for innovative civil projects, requiring more complex structural materials. One of the great achievements of early civilizations, particularly in the Middle East, was the use of simple concrete materials. While early concrete formulations were not self-cementing, peoples in Syria and Jordan had managed by 700 B.C. to discover hydraulic lime, which is able to set through a hydration process. These materials allowed the construction of cisterns under the desert floor that inhibited water from evaporating and thereby improved survival rates in the desert. To this day, hydraulic reactions are a vital component of concrete formation, and concrete in various formulations is the most common building material in civil projects around the world.

Modern concrete is a mixture of two main components: a paste and an aggregate. The aggregate mixtures most often consist of fine sand and coarser rock ingredients. Despite occasional use of the terms interchangeably, cement and concrete are different materials. Specifically, cement and water make up the paste component of concrete. Cement is typically less than 20% of the volume of a concrete mixture, although different mixtures can be formulated to suit a builder's purposes. As a paste of cement and water hardens due to hydration, the aggregate components of the mixture are bound together to form hardened concrete, which slowly strengthens over time.

As buildings continue to grow in height, stadiums expand in size, and bridge and highway projects continue to be planned with ever increasing ambition, there is a growing need for methods to increase the strength of concrete structures. The strength of concrete depends foremost on the mixture; a mixture lacking in aggregates will often crack easily, whereas a mixture lacking paste will often be plagued by air bubbles. These results are as expected, particularly when one considers that the paste plays the role of filling in gaps between aggregates.

Aside from modifying a concrete mixture, the properties of concrete are often improved by pre-stressing. Broadly speaking, a pre-stressing process consists of subjecting the concrete to compressive forces before the concrete is fully set and used as a structural panel. Conventional pre-stressing techniques employ steel tendons either within or around the concrete to subject the concrete to compression. This creates a hybrid material of concrete and steel which possesses desirable qualities of each, namely, concrete's inherent strength in compression and steel's inherent strength in tension. In addition to steel tendons, various polymer-based fiber reinforcement tendons have been explored and employed over the past three decades. Pre-stressed concrete is less likely to crack than non-stressed concrete, due to the compressive force imparted to the cast concrete structure by the pre-stressed reinforcing tendons. Pre-stressing thus discourages damage due to cracking from thermal expansion, which freeze-thaw cycles then exacerbate.

There are two main categories of pre-stressed concrete: post-tensioned concrete and pre-tensioned concrete. Post-tensioned concrete involves placing a sleeve over or around a hardened concrete structure. Once the concrete hardens, the tendons are placed in the sleeve and pulled tight, where they are locked in place through mechanisms that are dependent on the type of tendon employed. Pre-tensioned concrete involves placing the tendons under tension and anchoring them to an external object before the concrete is poured into a mold or form to cast the concrete into a unit or structure having a desired shape. The concrete then hardens around the tendons, which are then released from their anchors. The tendons attempt to return to their original conformation, but cannot due to being surrounded by concrete. The friction between the tendons and the concrete results in the tendons transferring their tension to the entire tendon-concrete system, thereby creating a pre-stressed concrete block, panel or other molded structure.

Techniques for pre-stressing concrete are in wide use today because they provide the following advantages:
Pre-stressed concrete members are substantially free from cracks and their resistance to the effects of impact, shock, and stresses is greater than for non-pre-stressed concrete structures.
Thinner sections of pre-stressed concrete members can be used for a longer span.
Concrete members employing pre-stressed reinforcing tendons are lighter in weight and more easily transportable.
Pre-stressed concrete members reduce the amount of construction materials required for a given building project.
   Pre-stressed concrete made with steel still has to be designed to protect the steel cable from corrosion, however.

Accordingly, improved systems for the production of pre-stressed cast concrete structures with embedded non-metallic fibrous reinforcing tendons in tension, as well as systems for imparting tension to non-metallic fibrous reinforcing tendons in pre-stressed concrete, would be advantageous.

### SUMMARY OF THE INVENTION

A pre-stressed cast concrete structure comprises a plurality of embedded fibrous reinforcing tendons in tension. Each of the fibrous reinforcing tendons comprises a plurality of continuous non-metallic fibers extending substantially the entire length of the tendon.

In various embodiments of the pre-stressed cast concrete structure, the non-metallic fibers are selected from the group consisting of basalt fibers, carbon fibers, polymeric fibers, glass fibers and mixtures thereof.

In some embodiments of the pre-stressed cast concrete structure, the non-metallic fibers are embedded in a composite matrix with a binding polymer. The binding polymer can be a thermoset resin such as epoxy, as well as other thermoset or thermoplastic polymers, such as polyester, vinyl ester or nylon.

An improved chuck assembly retains a fibrous reinforcing tendon in tension. The chuck assembly comprises:
(a) a cylindrical housing having an incoming end and an outgoing end, the housing having an interior surface that tapers inwardly from the outgoing end to the incoming end to form a central annular opening at the incoming end;
(b) a plurality of jaws, each of the jaws having an incoming end and an outgoing end, each of the jaws movable along the housing interior surface between the housing outgoing end and the housing incoming end, the jaws joined together at their outgoing ends;
(c) an end cap removably attached to the housing outgoing end, the end cap having a central annular opening formed therein; and
(d) a compression mechanism interposed between the end cap and the outgoing ends of the jaws, the compression mechanism normally biasing the jaws such that the jaw incoming ends converge to grasp a reinforcing tendon extending through the housing incoming end central annular opening and the end cap central annular opening when the housing incoming end abuts a stationary surface, each of the reinforcing tendons comprising a plurality of continuous non-metallic fibers extending substantially the entire length of the tendon.

In operation, each of the jaws contacts the reinforcing tendon in a manner to resist damage to the fibers of the reinforcing tendon. The jaws are designed to reduce the amount of compressive pressure imposed on the reinforcing tendon. The physical integrity of the tendon is preserved by employing jaws that have an elongated angle of contact and rounded edges, thereby spreading the load imparted by the jaws onto a greater surface area of the reinforcing tendon.

In an embodiment of the chuck assembly, each of the jaws has a semicircular channel formed in the interior surface thereof. The semicircular channel grasps the reinforcing tendon. The semicircular channel is preferably grooved or threaded.

In another embodiment of the chuck assembly, the semicircular channel has an incoming end and an outgoing end. The channel incoming end is flared in a direction away from the reinforcing tendon.

In a preferred embodiment of the chuck assembly, each of the jaws contacts the reinforcing tendon at an angle less than approximately 45 degrees.

In another embodiment of the chuck assembly, the plurality of jaws comprises at least three jaws. In a preferred embodiment, the plurality of jaws comprises three jaws.

In an embodiment of the chuck assembly, the compression mechanism is a coiled spring.

In an embodiment of the chuck assembly, the tendon is capable of reinforcing a concrete structure in compression.

In embodiments of the improved chuck assembly, the reinforcing tendon can be formed of basalt fibers, carbon fibers and/or polymeric fibers. Preferred polymeric fibers comprise an aramid material.

A system for pre-stressing a cast concrete structure comprises:
(a) a mold for containing a quantity of concrete, the mold comprising a pair of oppositely disposed end panels, each of the end panels having an interior surface and an exterior surface, each of the end panels having a plurality of openings formed therein, each of the openings in one of the end panels aligned with an opening in the other of the end panels;
(b) a plurality of fibrous reinforcing tendons, each of the reinforcing tendons comprising a plurality of continuous non-metallic fibers extending substantially the entire length of the tendon, each of the reinforcing tendons extending through aligned openings in the mold end panels;
(c) a plurality of improved chuck assemblies as set forth above, a pair of the chuck assemblies associated with each of the reinforcing tendons, one of the pair of chuck assemblies abutting the exterior surface of one of the mold end panels and the other of the chuck assemblies abutting the exterior surface of the other of the mold end panels;
(d) a tensioning mechanism associated with each of the reinforcing tendons, the tensioning mechanism capable of applying tension to an associated reinforcing tendon; and
(e) a quantity of concrete introduced to the mold, the concrete, when cured, rigidly surrounding the reinforcing tendons such that the reinforcing tendons are maintained in tension.

In embodiments of the foregoing system, the reinforcing tendon can be formed of basalt fibers, carbon fibers and/or polymeric fibers. Preferred polymeric fibers comprise an aramid material.

A method forming a pre-stressed cast concrete structure comprises:
(a) providing a mold for containing a quantity of concrete, the mold comprising a pair of oppositely disposed end panels, each of the end panels having an interior surface and an exterior surface, each of the end panels having a plurality of openings formed therein, each of the openings in one of the end panels aligned with an opening in the other of the end panels;
(b) extending each of a plurality of fibrous reinforcing tendons through aligned openings in the mold end panels, each of the reinforcing tendons comprising a plurality of continuous non-metallic fibers extending substantially the entire length of the tendon;
(c) providing a plurality of improved chuck assemblies as set forth above, a pair of the chuck assemblies associated with each of the reinforcing tendons, one of the pair of chuck assemblies abutting the exterior surface of one of the mold end panels and the other of the chuck assemblies abutting the exterior surface of the other of the mold end panels;
(d) applying tension to each of the reinforcing tendons via a tensioning mechanism associated with each of the reinforcing tendons;
(e) introducing a quantity of concrete to the mold, the concrete, when cured, rigidly surrounding the reinforcing tendons such that the reinforcing tendons are maintained in tension.

In embodiments of the foregoing method, the reinforcing tendon can be formed of basalt fibers, carbon fibers and/or polymeric fibers. Preferred polymeric fibers comprise an aramid material.

### BRIEF DESCRIPTION OF THE DRAWINGS

FIG. 1 is a schematic perspective view of a pre-stressing assembly for pre-stressing a concrete block.

FIG. 2A is a schematic end view of a chuck assembly for pre-stressing concrete using fibrous reinforcing tendons.

FIG. 2B is a side sectional view of the chuck assembly illustrated schematically in FIG. 2A.

FIG. 3 is an exploded perspective view of the chuck assembly illustrated in FIGS. 2A and 2B, also showing a portion of a fibrous reinforcing tendon being positioned in the central annular opening formed at the incoming end of the chuck assembly housing.

FIG. 4 is a detailed perspective view of a chuck assembly end cap, in which a pair of attachment pins that extend from the end cap fit within cooperating slots in the outgoing end of the chuck assembly housing.

FIG. 5A is a schematic perspective view showing the initial set-up stage of a system for pre-stressing a cast concrete structure. FIG. 5B is a schematic perspective view showing the tensioning stage of a system for pre-stressing a cast concrete structure.

FIG. 6 is a side view of a fibrous reinforcing tendon.

FIG. 7 is a schematic perspective view, partially in section, of a pre-stressed cast concrete structure with four fibrous reinforcing tendons prior to the release and removal of the chuck assemblies from the ends of the mold.

### DETAILED DESCRIPTION OF ILLUSTRATIVE EMBODIMENT(S)

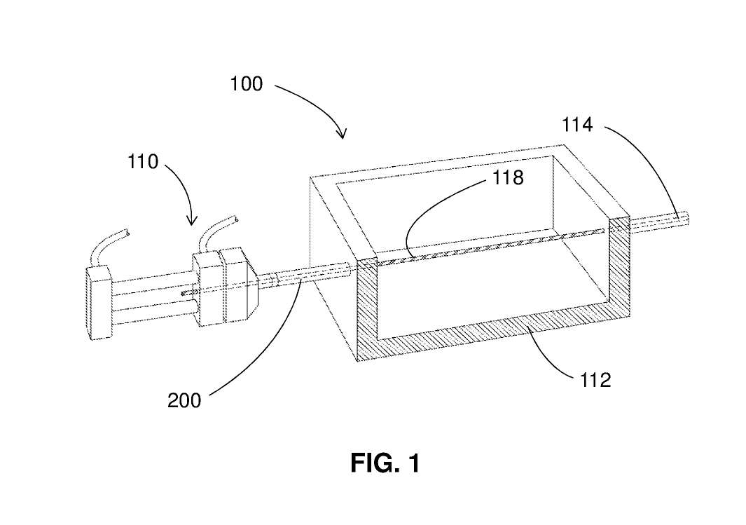

Turning first to FIG.1, an illustrative embodiment of a pre-stressing system 100 has a concrete mold 112, through which a reinforcing tendon 118 extends. Reinforcing tendon 118 is clamped within chuck assembly 200 at one end of mold 112 and is clamped within chuck assembly 114 on the other, oppositely disposed end of mold 112. A tensioning mechanism 110 imparts tension to reinforcing tendon 118 by drawing reinforcing tendon 118 in a direction away from mold 112.

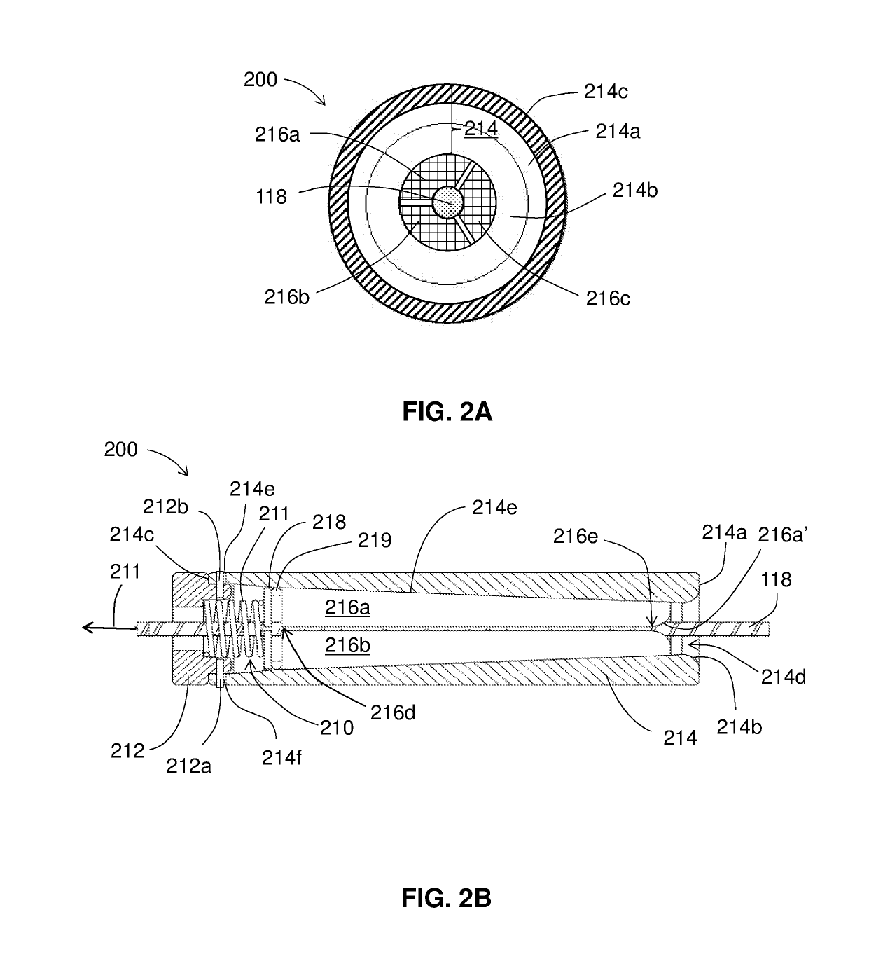

FIGS. 2A and 2B illustrate in further detail chuck assembly 200 shown in FIG. 1. In the end view depicted schematically in FIG. 2A, chuck assembly 200 includes a cylindrical housing 214 and a plurality of three jaws 216a, 216b and 216c extending within cylindrical housing 214 for grasping a fibrous reinforcing tendon 118. Cylindrical housing 214 is shown as comprising a flat end surface 214a and a flared end surface 214b and, at its opposite end, a relatively thinner surface 214c (shown in hatched shading).

As shown in FIG. 2B, chuck assembly 200 comprises cylindrical housing 214, a plurality of jaws, two of which are shown as jaws 216a and 216b, an end cap 212 and a compression mechanism 210. Cylindrical housing 214 has an incoming end with a flat surface 214a and a flared surface 214b, and an outgoing end with a flat surface 214c. Cylindrical housing 214 has an interior surface 214e that tapers inwardly from outgoing end surface 214c to incoming end surface 214a to form an annular opening 214d at its incoming end.

As further shown in FIG. 2B, chuck assembly 200 comprises a plurality of jaws, two of which are shown as jaws 216a and 216b. Each of jaws 216a and 216b is movable in the longitudinal direction between cylindrical housing outgoing end 214c and incoming end 214a, and vice versa. Jaws 216a, 216b and 216c (hidden behind jaws 216a and 216b in FIG. 2B) are joined together at their outgoing ends depicted at juncture 216d.

As further shown in FIG. 2B, chuck assembly 200 comprises an end cap 212, from which a pair of attachment pins 212a and 212b extend. Pins 212a and 212b cooperate with aligned slots 214e and 214f formed in cylindrical housing 214 to removably attach end cap 112 to cylindrical housing 214.

As further shown in FIG. 2B, chuck assembly 200 comprises a compression mechanism 210 interposed between end cap 212 and the outgoing ends of jaws 216a, 216b and 216c. In the embodiment shown in FIG. 2B, compression mechanism 210 comprises a coiled spring 211 that applies compressive force to jaws 216a, 216b and 216c via a compression plate 218. An optional bushing 219 is interposed between compression plate 218 and jaws 216a, 216b and 216c. Compression mechanism 210 normally biases jaws 216a, 216b and 216c such that the jaws' incoming ends converge at region 216e to grasp a reinforcing tendon 118 extending through housing incoming end central annular opening 214d when housing incoming end surface 214a abuts a stationary surface (not shown in FIG. 2B). Each of jaws 216a, 216b and 216c contacts fibrous reinforcing tendon 118 in a manner to resist breakage, severing or other damage that compromises of the properties of the fibrous structure at the exterior surface of reinforcing tendon 118.

In operation, when reinforcing tendon 118 is drawn through housing outgoing end central annular opening 214c in the direction of arrow 211, jaws 216a, 216b and 216c are released from contact with reinforcing tendon 118 to permit movement within cylindrical housing 214 and resultant tensioning of reinforcing tendon 118. When the tensioning of reinforcing tendon 118 is released, jaws 216a, 216b and 216c are urged in a direction opposite arrow 211 and the interior surfaces of jaws 216a, 216b and 216c will then contact, grasp and maintain reinforcing tendon 118 in its tensioned state.

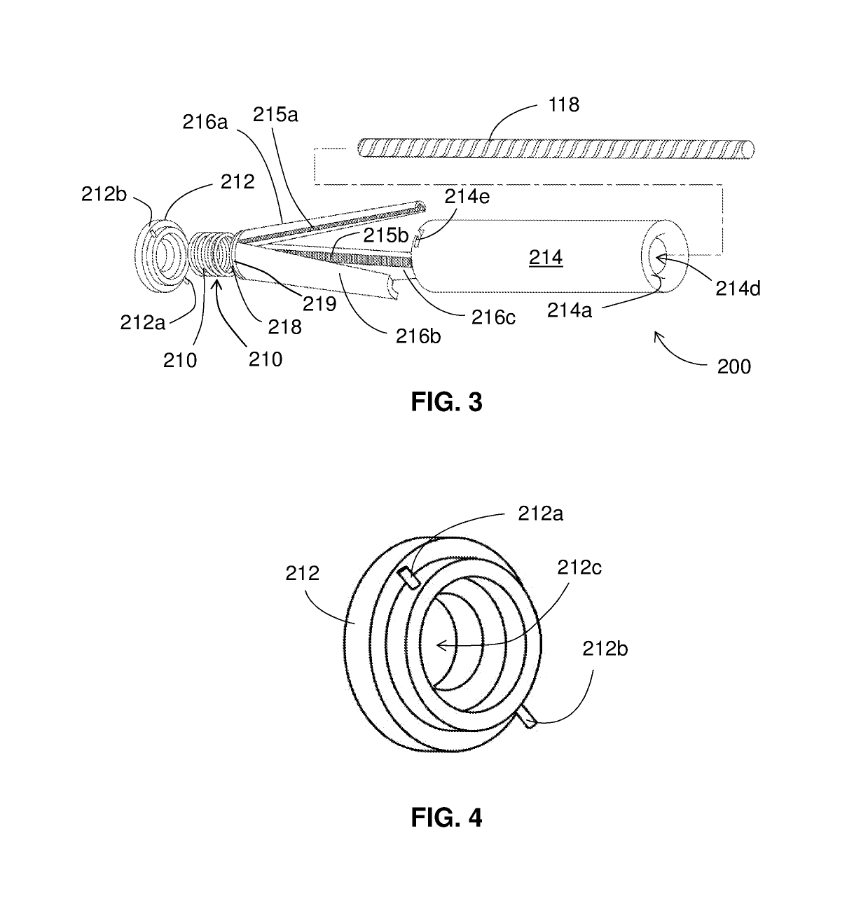

FIG. 3 shows an exploded perspective view of chuck assembly 200, also showing, via broken lines, a portion of a fibrous reinforcing tendon 118 being positioned in central annular opening 214d formed at the incoming end of cylindrical housing 214. FIG. 3 also shows the configuration of the plurality of three jaws 216a, 216b and 216c. End cap 212 has outwardly extending attachment pins 212a and 212b, which cooperate with aligned slots, one of which is shown in FIG. 3 as slot 214e, to removably attach end cap 212 to cylindrical housing 214.

FIG. 3 further illustrates the positioning of compression mechanism 210, which is interposed between end cap 212 and the outgoing ends of jaws 216a, 216b and 216c. In the embodiment shown in FIG. 3, compression mechanism 210 is coiled spring 211. An optional bushing 219 is interposed between compression mechanism 210 and the outgoing ends of jaws 216a, 216b and 216c. Compression mechanism 210 normally biases jaws 216a, 216b and 216c such that the incoming ends of the jaws converge to grasp reinforcing tendon 118 when housing incoming end surface 214a abuts a stationary surface (not shown in FIG. 3). As further shown in FIG. 3, each of jaws 216a, 216b and 216c has a semicircular channel, two of which are shown in FIG. 3 as semicircular channels 215a and 215b, formed in its interior surface. Reinforcing tendon 118 is grasped between the semicircular channels of jaws 216a, 216b and 216c. As shown in FIG. 3, semicircular channels 215a and 215b are preferably grooved or threaded to increase the frictional capacity of semicircular channels 215a and 215b to grasp reinforcing tendon 118. Each of semicircular channels 215a and 215b also has an incoming end that is flared in a direction away from reinforcing tendon 118, as depicted by flared jaw incoming end surface 216a′ in FIG. 2B.

FIG. 4 is a detailed perspective view of a chuck assembly end cap 212, which has a pair of outwardly extending attachment pins 212a and 212b that cooperate with slots formed in the outgoing end of the chuck assembly housing to removably attached end cap 212 to the chuck assembly housing (not shown in FIG. 4). A central annular opening 212c is formed in end cap 212

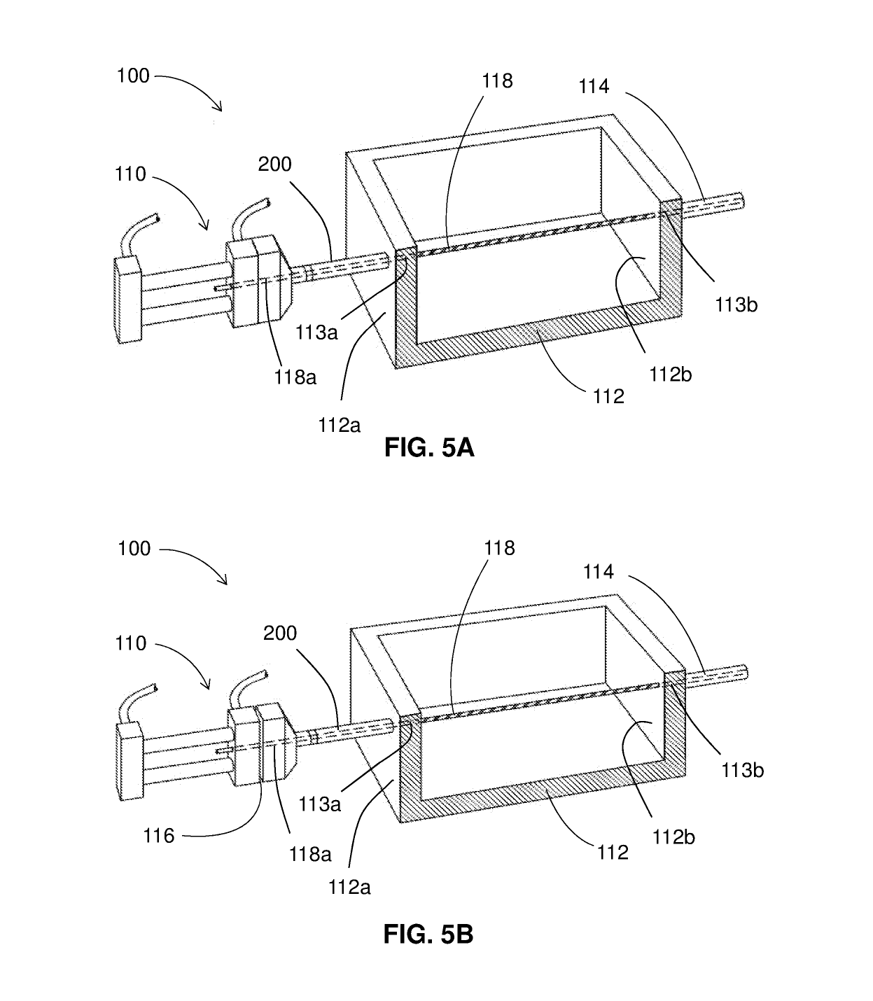

FIG. 5A schematically illustrates the initial set-up stage of a system 100 for pre-stressing a cast concrete structure. In the initial set-up stage, a reinforcing tendon 118 extends through openings 113a and 113b formed in oppositely disposed end panels 112a and 112b, respectively, of concrete mold 112. One end of reinforcing tendon 118 is restrained in its position with respect to mold end panel 112b by chuck assembly 114. The other end of reinforcing tendon 118 is restrained in its position with respect to mold end panel 112a by chuck assembly 200. A tensioning mechanism, depicted in FIG. 5A as a commercially available pneumatic ram device 110, rigidly grasps an end portion 118a of reinforcing tendon 118.

FIG. 5B schematically illustrates the tensioning stage of a system for pre-stressing a cast concrete structure. In the tensioning stage, tensioning mechanism 110 grasps reinforcing tendon 118 and draws it in a direction away from mold 112 for a distance indicated by the width of space 116. When the tensioning imparted by tensioning mechanism 110 to reinforcing tendon 118 is released, cylindrical housing 200 maintains reinforcing tendon 118 in its tensioned state.

The set-up and tensioning stages can be performed iteratively, as necessary, to achieve the desired amount of draw, and resultant tension, imparted to the reinforcing tendon.

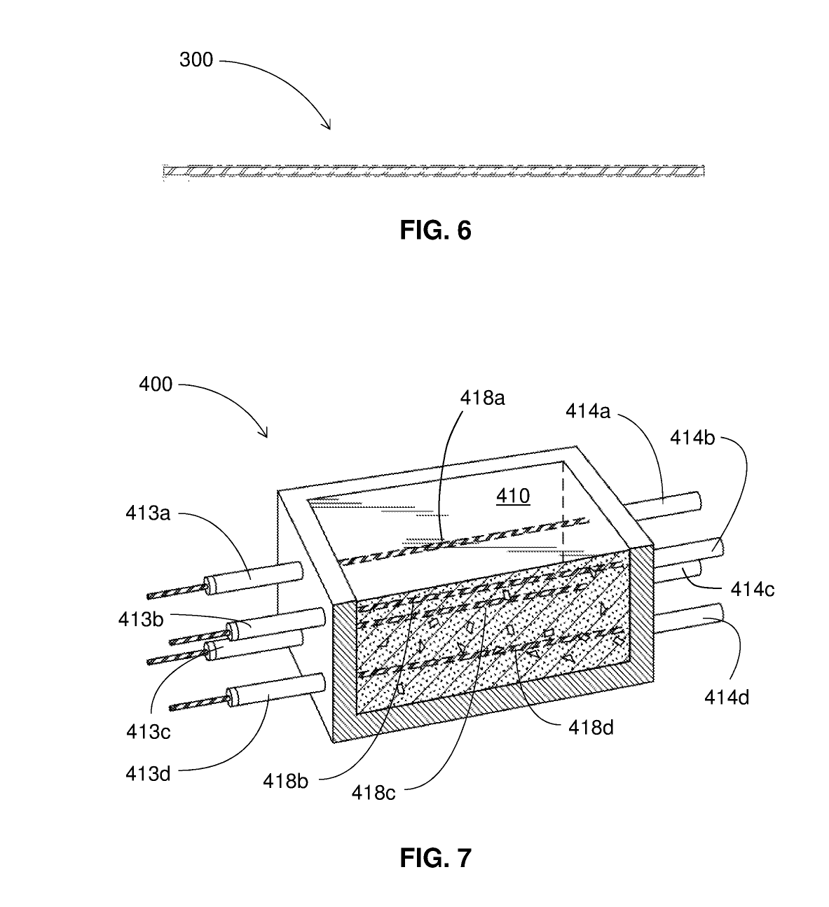

FIG. 6 illustrates a side view of a fibrous reinforcing tendon 300. Fibrous reinforcing tendon 300 can be formed of basalt fibers, carbon fibers and/or polymeric fibers. Particularly suitable polymeric fibers can be formed from aramid polymers commercially available under the tradenames KEVLAR® and NOMEX®. The non-metallic fibers are typically embedded in a composite matrix with a binding polymer. The binding polymer can be a thermoset resin such as epoxy, as well as other thermoset or thermoplastic polymers, such as polyester, vinyl ester or nylon.

FIG. 7 illustrates a system 400 for pre-stressing a cast concrete structure 410 with four fibrous reinforcing tendons 418a, 418b, 418c and 418d extending through a mold 412. Fibrous reinforcing tendons 418a, 418b, 418c and 418d are tensioned in a manner described with respect to FIGS. 5A and 5B and their corresponding text set forth herein. The tensioned fibrous reinforcing tendons 418a, 418b, 418c and 418d are held in place on one side of mold 412 by chuck assemblies 413a, 413b, 413c and 413d, respectively, and on the other side of mold 412 by chuck assemblies 414a, 414b, 414c and 414d, respectively. Once a quantity of concrete 417 is introduced into mold 412 and has sufficiently set, the chuck assemblies can be removed and the tensioned reinforcing tendons will be transferred as compressive force applied to cast concrete structure 410.

An important advantage of the cast concrete structures produced by the present system and method is ability to design cast concrete structures to carry a specified load without the need to protect the reinforcing tendons from corrosion. Less concrete can therefore be used when corrosion-resistant, non-metallic fibrous reinforcing tendons are employed. Since the cast concrete structures using non-metallic, fibrous reinforcing elements are lighter, the dead load is less so the magnitude of the underlying supporting structure can be reduced, including the underlying foundation in most cases. This results in overall cost savings for the building project. Additionally, a greater number of cast concrete structures using fibrous reinforcing tendons can also be transported on a single truck due to the lighter weight of the cast concrete structures. Smaller cranes can also be used with lighter weight cast concrete structures using fibrous reinforcing tendons or, alternatively, larger cranes will have a longer reach due to the lighter weight of cast concrete structures using fibrous reinforcing tendons.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A pre-stressed cast concrete structure comprising a plurality of embedded fibrous reinforcing tendons in tension, wherein each of said fibrous reinforcing tendons comprising a plurality of continuous non-metallic fibers extending substantially the entire length of said tendon.

2. The pre-stressed cast concrete structure of claim 1, wherein said non-metallic fibers are selected from the group consisting of basalt fibers, carbon fibers, polymeric fibers, glass fibers and mixtures thereof.

3. The pre-stressed cast concrete structure of claim 1, wherein said non-metallic fibers are embedded in a composite matrix with a binding polymer comprising a thermoset resin or a thermoplastic resin.

4. The pre-stressed cast concrete structure of claim 3, wherein said binding polymer is selected from the group comprising epoxy, a polyester, a vinyl ester or nylon.

5. A chuck assembly for retaining a fibrous reinforcing tendon in tension, the chuck assembly comprising:
(a) a cylindrical housing having an incoming end and an outgoing end, said housing having an interior surface that tapers inwardly from said outgoing end to said incoming end to form a central annular opening at said incoming end;
(b) a plurality of jaws, each of said jaws having an incoming end and an outgoing end, each of said jaws movable along said housing interior surface between said housing outgoing end and said housing incoming end, said jaws joined together at their outgoing ends;
(c) an end cap removably attached to said housing outgoing end, said end cap having a central annular opening formed therein; and
(d) a compression mechanism interposed between said end cap and said outgoing ends of said jaws, said compression mechanism normally biasing said jaws such that said jaw incoming ends converge to grasp a reinforcing tendon extending through said housing incoming end central annular opening and said end cap central annular opening when said housing incoming end abuts a stationary surface, each of said reinforcing tendons comprising a plurality of continuous non-metallic fibers extending substantially the entire length of said tendon;
wherein each of said jaws contacts said reinforcing tendon in a manner to resist damage to said fibers.

6. The chuck assembly of claim 5, wherein each of said jaws has a semicircular channel formed in the interior surface thereof, said semicircular channel grasping said reinforcing tendon.

7. The chuck assembly of claim 6, wherein said semicircular channel is grooved or threaded.

8. The chuck assembly of claim 7, wherein said semicircular channel has an incoming end and an outgoing end and wherein said channel incoming end is flared in a direction away from said reinforcing tendon.

9. The chuck of claim 6, wherein each of said jaws contacts said reinforcing tendon at an angle less than approximately 45 degrees.

10. The chuck assembly of claim 5, wherein said plurality of jaws comprises at least three jaws.

11. The chuck assembly of claim 10, wherein said plurality of jaws comprises three jaws.

12. The chuck assembly of claim 5, wherein said compression mechanism is a coiled spring.

13. The chuck assembly of claim 5, wherein said tendon is capable of reinforcing a concrete structure in compression.

14. The chuck assembly of claim 13, wherein said non-metallic fibers are selected from the group consisting of basalt fibers, carbon fibers, polymeric fibers, glass fibers and mixtures thereof.

15. The chuck assembly of claim 14, wherein said polymeric fibers are formed from an aramid material.

16. A system for pre-stressing a cast concrete structure, the system comprising:
(a) a mold for containing a quantity of concrete, said mold comprising a pair of oppositely disposed end panels, each of said end panels having an interior surface and an exterior surface, each of said end panels having a plurality of openings formed therein, each said openings in one of said end panels aligned with an opening in the other of said end panels;
(b) a plurality of reinforcing tendons, each of said reinforcing tendons extending through aligned openings in said mold end panels, each of said reinforcing tendons comprising a plurality of continuous non-metallic fibers extending substantially the entire length of said tendon;
(c) a plurality of chuck assemblies according to claim 1, a pair of said chuck assemblies associated with each of said reinforcing tendons, one of said pair of chuck assemblies abutting the exterior surface of one of said mold end panels and the other of said chuck assemblies abutting the exterior surface of the other of said mold end panels;
(d) a tensioning mechanism associated with each of said reinforcing tendons, said tensioning mechanism capable of applying tension to an associated reinforcing tendon;
(e) a quantity of concrete introduced to said mold, said concrete when cured rigidly surrounding said reinforcing tendons such that said reinforcing tendons are maintained in tension.

17. The system of claim 16, wherein said non-metallic fibers are selected from the group consisting of basalt fibers, carbon fibers, polymeric fibers, glass fibers and mixtures thereof.

18. A method forming pre-stressing a cast concrete structure, the method comprising:
(a) providing a mold for containing a quantity of concrete, said mold comprising a pair of oppositely disposed end panels, each of said end panels having an interior surface and an exterior surface, each of said end panels having a plurality of openings formed therein, each said openings in one of said end panels aligned with an opening in the other of said end panels;
(b) extending each of a plurality of reinforcing tendons through aligned openings in said mold end panels, each of said reinforcing tendons comprising a plurality of continuous non-metallic fibers extending substantially the entire length of said tendon;
(c) providing a plurality of chuck assemblies according to claim 1, a pair of said chuck assemblies associated with each of said reinforcing tendons, one of said pair of chuck assemblies abutting the exterior surface of one of said mold end panels and the other of said chuck assemblies abutting the exterior surface of the other of said mold end panels;
(d) applying tension to each of said reinforcing tendons via a tensioning mechanism associated with each of said reinforcing tendons;
(e) introducing a quantity of concrete to said mold, said concrete when cured rigidly surrounding said reinforcing tendons such that said reinforcing tendons are maintained in tension.

19. The method of claim 18, wherein said non-metallic fibers are selected from the group consisting of basalt fibers, carbon fibers, polymeric fibers, glass fibers and mixtures thereof.
